(19) United States
(12) Patent Application Publication
(10) Pub. No.: US 2026/0291252 A1
(43) Pub. Date: Sep. 24, 2026

(54) CURVATURE-BASED CONTROL SYSTEM AND METHOD FOR DC POWER SOURCES

(71) Applicant: Sparq Systems Inc., Kingston (CA)

(72) Inventors: Arpan LAHA, Kingston (CA); Abirami KALATHY, Kingston (CA); Majid PAHLEVANINEZHAD, Kingston (CA); Praveen K. JAIN, Kingston (CA)

(21) Appl. No.: 19/084,914

(22) Filed: Mar. 20, 2025

(51) Int. Cl. H02J 3/46; H02J 3/38; H02M 7/493

(52) U.S. Cl. CPC H02J 3/46; H02J 3/381; H02M 7/493; H02J 2101/25; H02J 2103/30

(57) ABSTRACT

Systems and methods for controlling a behaviour of a DC power source in a power generation system. A DC power source (e.g. a DC/DC converter coupled to one or more photovoltaic panels) has its output characteristics measured and a curvature of a plot of those output characteristics is estimated. Based on whether the control system is in on-grid or off-grid mode, the curvature estimate is used to control the behaviour of the DC power source. When in on-grid mode, the curvature estimate is used in MPPT. When in off-grid mode, the curvature estimate is used to optimize power sharing among DC/DC converters and the inverters in the power generation system as well as to regulate a bus voltage. The curvature may be a power-voltage curve for the DC power source.

### TECHNICAL FIELD

The present invention relates to power generation systems. More specifically, the present invention relates to systems and methods for use in power generation systems that use renewable energy sources such as photovoltaic panels, wind power generators, and battery systems used for such purposes.

### BACKGROUND

Solar microinverters are in high demand due to their attractive features such as individual maximum power point tracking (MPPT), high performance, and ease of installation. Their MPPT capability ensures maximum solar energy harvesting from photovoltaic panels. These inverters can operate in dual mode, delivering clean AC electricity to the grid while also supplying power to local loads when the grid is unavailable. Their ability to seamlessly switch between grid-tied and off-grid operation makes them suitable for various applications, including residential and commercial use and for use in remote areas without reliable grid access. Additionally, microinverters offer plug-and-play functionality and modularity, enabling easy system scaling to accommodate additional solar panels without extensive reconfiguration.

A major problem in the operation of solar or photovoltaic microinverters is the intermittency of solar power. This issue is further complicated by the limited energy storage capacity of the microinverters, leading to difficulties in managing solar power fluctuations and load variations. Typically, a relatively small DC-bus capacitor is used for storage, which makes photovoltaic off-grid systems reliant on energy storage systems (ESSs) for stable operation. However, ESSs can be costly and can pose additional challenges, including environmental impacts from their production and disposal. Another factor against ESSs is that solar microinverters are capable of delivering power in standalone mode without the need for ESSs in many applications where power is required during the day (e.g., remote sites). Therefore, achieving reliable off-grid operation of solar microinverters without corresponding ESSs presents an attractive and cost-effective solution for many applications. The reliability of solar microinverters is hinged on the ability of control systems to swiftly handle transients caused by fluctuations in both the power sources and the loads receiving the power.

FIG. 1 shows a block diagram of a typical existing power generation system that uses a droop-based power sharing scheme (Prior Art). Controllers that use droop control techniques are widely employed for the parallel operation of inverters due to their plug-and-play functionality, simple implementation, reliability, and the lack of a need for communication systems. The droop-based control system generates a voltage reference signal within a predetermined range, typically achieved through a closed-loop control system. Both the AC voltage and frequency are regulated using the droop control mechanism. In large-scale distribution systems with significant feeder inductances, the inductive droop method is predominantly employed. In contrast, in small-scale systems with resistive networks, the resistive droop method is applied. In this resistive droop method, the AC voltage amplitude is adjusted based on the active power, while the frequency is controlled according to the reactive power delivered. Using these parameters, a sinusoidal reference signal for the output voltage is generated.

FIG. 2 shows a block diagram of an existing solution for operating DC/DC converters used in solar microinverters (Prior Art). During grid-tied operation, the MPPT controller tracks the maximum power point (MPP) using hill-climbing algorithms (such as perturb and observe or incremental conductance). The step size of the voltage perturbation determines both the speed of convergence of the algorithm and the oscillations around the MPP. In the off-grid scenario, the DC bus voltage needs to be regulated by the DC/DC converters. As shown in FIG. 2, a bus voltage controller (e.g. proportion-integral controller) is employed to regulate the bus voltage. The output of the bus voltage controller is added to the output of the MPPT controller to ensure that the system operates between the open circuit voltage and the MPP voltage region on the PV (power-voltage) curve. This operating region is preferred because, below the MPP voltage, under light load conditions, the system operates near the short-circuit region of the PV curve, where the photovoltaic voltage is very low. In this scenario, the system may be unable to produce the required gain for the DC/DC converter, potentially leading to the collapse of the DC bus voltage.

Several challenges are associated with the control methods used in the Prior Art. In droop-based controllers, as shown in FIG. 1, power sharing among inverters is dictated solely by load demand, while the voltage and frequency set points established by the controller remain independent of the power generation capacity of individual input sources. Droop control assumes uniform input conditions across all inverters. However, in microinverter systems, each unit may experience varying solar conditions, which could lead to inaccurate power distribution. This issue becomes problematic when the maximum power generation capacity of a power source connected to an inverter is lower than the power reference set by the droop controller, even if the total power generation capacity of all sources exceeds the total load demand. In such cases, the entire system may fail because the inverter linked to the lower-capacity source cannot meet its power demand. During MPPT operation, as shown in FIG. 2, a larger step size enables the algorithm to reach the MPP faster but introduces greater oscillations, reducing energy harvesting efficiency. Conversely, a smaller step size minimizes oscillations and improves energy harvesting but increases the time required for the control system to reach the MPP. A smaller step size also reduces the system's ability to react to rapid changes in environmental conditions, which can shift the MPP quickly. Therefore, an adaptive step size is needed to optimize the MPPT algorithm. A significant issue with the off-grid control method shown in FIG. 2 (Prior Art) is the slow dynamics of the control system. The power delivery speed during start-up is governed by the MPPT algorithm, as the output of the bus voltage controller is restricted to positive values to prevent operation in the short-circuit region of the PV curve. Additionally, rapidly changing environmental conditions can cause the MPP voltage to shift, potentially causing the controller to become stuck below the MPP voltage. Consequently, the controller cannot respond quickly to rapid transients caused by fluctuations in solar input or load demand, which can lead to bus voltage collapse and system interruptions. Although some of these problems can be partially mitigated by existing methods, they cannot fully address issues caused by severe solar and load fluctuations, often failing to provide optimal performance.

Based on the above, there is a need for systems and devices that mitigate, if not completely avoid, the shortcomings of the prior art.

### SUMMARY

The present invention provides systems and methods for controlling, in a power generation system, a behaviour of a DC power source and/or an AC output of an inverter. A DC power source (e.g. a DC/DC converter coupled to one or more photovoltaic panels) has its output characteristics measured and a curvature of a plot of those output characteristics is estimated. Based on whether the control system is in on-grid or off-grid mode, the curvature estimate is used to control the behaviour of the DC power source and/or an AC output of an inverter in the same power generation system. When in on-grid mode, the curvature estimate is used in MPPT. When in off-grid mode, the curvature estimate is used to regulate a bus voltage for the power generation system. The curvature may be a power-voltage curve for the DC power source. Alternatively, other curves, such as power-voltage, power-current, or power-squared vs. voltage may be used. The curve of any characteristic that exhibits maximum curvature at the maximum power point (MPP) may be used.

In a first aspect, the present invention provides a control subsystem for controlling a DC power source in a power generation system, the control subsystem comprising:
an MPPT controller for controlling power from said DC power source to thereby provide maximum power to a power grid when said control subsystem is in on-grid mode;
a bus voltage controller for controlling said power from said DC power source to thereby provide said power to off-grid loads when said control subsystem is in off-grid mode;
wherein said power generation system exclusively provides power to said power grid when said control subsystem is in said on-grid mode;
said power generation system exclusively provides power to said off-grid loads when said control subsystem is in said off-grid mode;
when said control subsystem is in on-grid mode, said control subsystem uses an estimate of a curvature of an output characteristic of said DC power source to perform maximum power point tracking with said DC power source;
when said control subsystem is in off-grid mode, said control subsystem uses said estimate of said curvature for said output characteristic of said component of said DC power source to perform at least one of:
   determining a power reference signal that is used in regulating a bus voltage for said power generation system;
   adjusting power sharing between a plurality of DC/DC converters that are connected to a DC bus of an AC inverter in said power generation system; and
   adjusting power sharing between different AC inverters that are connected at a point of common coupling in said power generation system.

In another aspect, the DC power source comprises a DC/DC converter and at least one photovoltaic panel coupled to said DC/DC converter. The output characteristic may be a power-voltage characteristic for said DC power source and the power-voltage characteristic is derived from sensed current and voltage outputs of said DC power source.

In a further aspect, the control subsystem comprises a switching modulator block for controlling switches in said DC/DC converter based on input from either said MPPT controller or said bus voltage controller;
wherein
when said control subsystem is in said on-grid mode, said switching modulator block receives input from said MPPT controller; and
when said control subsystem is in said off-grid mode, said switching modulator receives input from said bus voltage controller.

Yet a further aspect provides that the control subsystem further comprises a curvature estimation block, said curvature estimation block receiving output parameters of said DC power source;
wherein
said curvature estimation block provides said estimate of said curvature for said output characteristic for said DC power source based on said output parameters;
said MPPT controller and said bus voltage controller receive said estimate from said curvature estimation block.

In a second aspect, the present invention provides a power generation system comprising:
a plurality of photovoltaic panels;
a plurality of DC/DC converters coupled at their outputs, each of said plurality of DC/DC converters being coupled at its input to at least one of said plurality of photovoltaic panels;
a DC/AC inverter receiving DC outputs of said plurality of DC/DC converters to thereby produce AC power;
a DC/DC control subsystem for providing signals to control semiconductors in said plurality of DC/DC converters;
a DC/AC control subsystem for providing signals to control semiconductors in said DC/AC inverter;
wherein
said power generation system switchably operates exclusively in either on-grid mode or off-grid mode;
when said power generation system is in on-grid mode, AC power from said DC/AC inverter is routed to a power grid;
when said when said power generation system is in off-grid mode, AC power from said DC/AC inverter is routed to at least one off-grid load;
each of said plurality of DC/DC converters is paired with at least one corresponding photovoltaic panel to result in a DC power source such that each DC/DC converter is coupled to its corresponding at least one photovoltaic panel and such that said plurality of DC/DC converters and said plurality of photovoltaic panels result in a plurality of DC power sources for said power generation system;
said DC/DC control subsystem uses estimated curvatures of output characteristics of said DC power sources to control a behavior of said DC power sources;
said DC/AC control subsystem uses said estimated curvatures of output characteristics of said DC power sources to control a behavior of said DC/AC inverter.

In a further aspect, each specific DC power source of said plurality of DC power sources is independently controlled by said DC/DC control subsystem from other specific DC power sources of said plurality of DC power sources and each specific DC power source of said plurality of DC power sources is controlled based on an estimated curvature of an output characteristic of said specific DC power source. Yet a further aspect provides that, when said power generation system is operating in off-grid mode, said DC/AC control subsystem uses said estimated curvatures to regulate an output AC voltage to within a predefined range.

The DC/DC control subsystem may comprise:
an MPPT controller for controlling power from said specific DC power source to thereby provide maximum power to said power grid when said power generation system is operating in on-grid mode;
a bus voltage controller for controlling said power from said specific DC power source to thereby provide said power to said at least one off-grid load when said power generation system is operating in off-grid mode.

The DC/DC control subsystem may further comprise a switching modulator block for controlling switches in a DC/DC converter for said specific DC power source based on input from either said MPPT controller or said bus voltage controller;
wherein
when said power generation system is operating in on-grid mode, said switching modulator block receives input from said MPPT controller; and
when said power generation system is operating in off-grid mode, said switching modulator receives input from said bus voltage controller.

The DC/DC control subsystem may further comprise a curvature estimation block, said curvature estimation block receiving output parameters of said specific DC power source;
wherein
said curvature estimation block provides said estimate of said curvature for said output characteristic for said specific DC power source based on said output parameters;
said MPPT controller and said bus voltage controller receives said estimate from said curvature estimation block.

In a further aspect, for each specific DC power source, when said power generation system is operating in off-grid mode, said DC/DC control subsystem uses said estimate of said curvature of said output characteristic for said specific DC power source to adjust a DC bus voltage for said power generation system towards a set value.

In yet a further aspect, for each specific DC power source, when said power generation system is operating in on-grid mode, said DC/DC control subsystem uses said estimate of said curvature of said output characteristic for said specific DC power source to perform maximum power point tracking with said specific DC power source.

In another aspect, the output characteristic is derived from sensed current and voltage outputs of said at least one component of said specific DC power source.

In a further aspect, the output characteristic is one of:
a power-voltage characteristic;
a power-current characteristic;
a power-squared vs. voltage characteristic; and
an output characteristic that exhibits maximum curvature at a maximum power point (MPP).

Another aspect provides that the output characteristic is a power-voltage characteristic for said specific DC power source and said power-voltage characteristic is derived from sensed current and voltage outputs of said specific DC power source.

In a third aspect of the present invention, there is provided a method for controlling a power generation system, the method comprising:
a) determining output characteristics of a DC power source that is part of said power generation system;
b) estimating a curvature of said output characteristics when said output characteristics are plotted to result in an estimated curvature;
c) using said estimated curvature to generate a reference signal that adjusts a behavior of said power generation system.

In a further aspect, step c) comprises using said estimated curvature in maximum power point tracking (MPPT) for said DC power source.

Yet a further aspect provides that step c) comprises using said estimated curvature in a search for a maximum power point for said DC power source.

Another aspect provides that the estimated curvature may be used in one or more of:
determining a power reference signal that is used in regulating a bus voltage for said DC power source;
determining power sharing between said plurality of DC/DC converters that are connected to a DC bus of an inverter in said power generation system; and
determining power sharing between different inverters connected at a point of common coupling in said power generation system.

In one more aspect, the DC power source comprises a DC-DC converter and at least one photovoltaic panel coupled to said DC-DC converter.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a typical power generation system according to the prior art;

FIG. 2 is a block diagram of an existing solution for operating DC/DC converters for solar microinverters according to the prior art;

FIG. 3 is a block diagram of a curvature-based control system;

FIG. 4 is a block diagram of a curvature-based microinverter control system with on-grid and off-grid functionality according to one aspect of the present invention;

FIG. 5 shows a power-voltage curve for a photovoltaic panel;

FIG. 6 details an example method for calculating discrete curvature in real time;

FIG. 7 illustrates a schematic diagram for a curvature-based control system for DC/DC converters in a two-stage solar microinverter;

FIG. 8 is a flowchart detailing the steps in a method for MPPT during on-grid operation of solar microinverters;

FIG. 9 details an example configuration of functional blocks for performing MPPT using curvature estimation;

FIG. 10 is a flowchart detailing the steps in an off-grid method for tracking an operating region of the photovoltaic system relative to MPP;

FIG. 11 is a flowchart for a method that tracks the Vₘₚₚ point to optimize the MPP search process during off-grid conditions;

FIG. 12 illustrates key waveforms that show the optimizing of solar microinverter operation based on curvature-based control while performing MPPT;

FIG. 13 illustrates key waveforms showing off-grid operation of DC/DC converters with different power ratings in response to a load transient;

FIG. 14 illustrates key waveforms showing off-grid operation of DC/DC converters with the same power rating during a change in irradiance on one of the photovoltaic panels; and

FIG. 15 is a flowchart showing the steps in a generalized method for controlling a DC power source using curvature estimation.

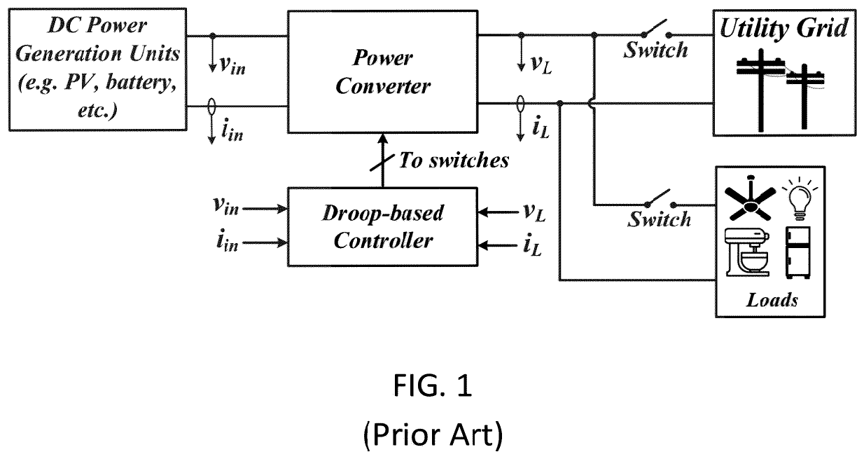

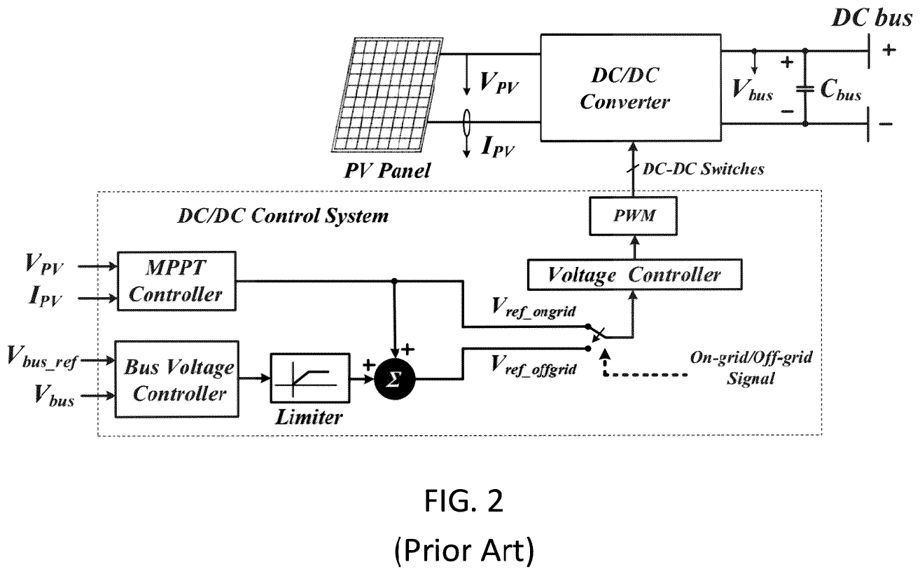

### DETAILED DESCRIPTION

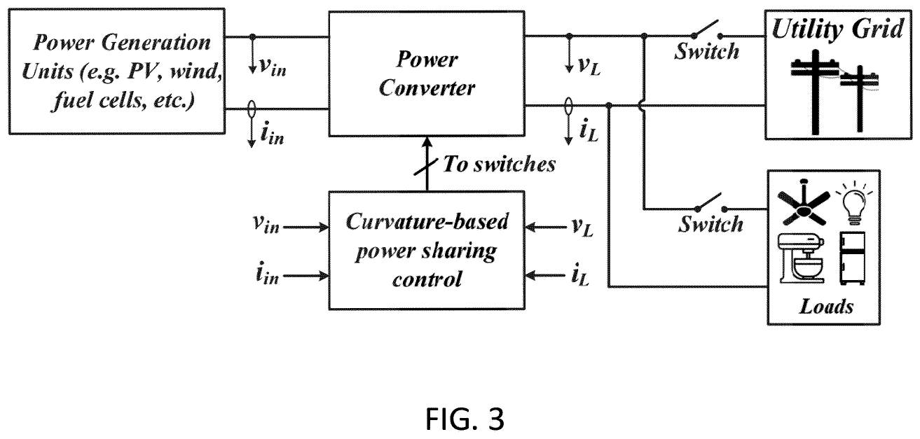

Referring to FIG. 3, a block diagram of a curvature-based control system is presented. The control system in FIG. 3 can be utilized for various power conversion systems that incorporate distributed energy resources such as solar power, wind power, fuel cells, etc. Unlike the previously discussed droop control strategy, the curvature-based control adjusts the power output of the inverters according to the maximum power output capacity of the distributed energy resources. This approach facilitates more sophisticated power sharing schemes among parallel-connected inverters based on the relative generation capacities of the input DC power sources.

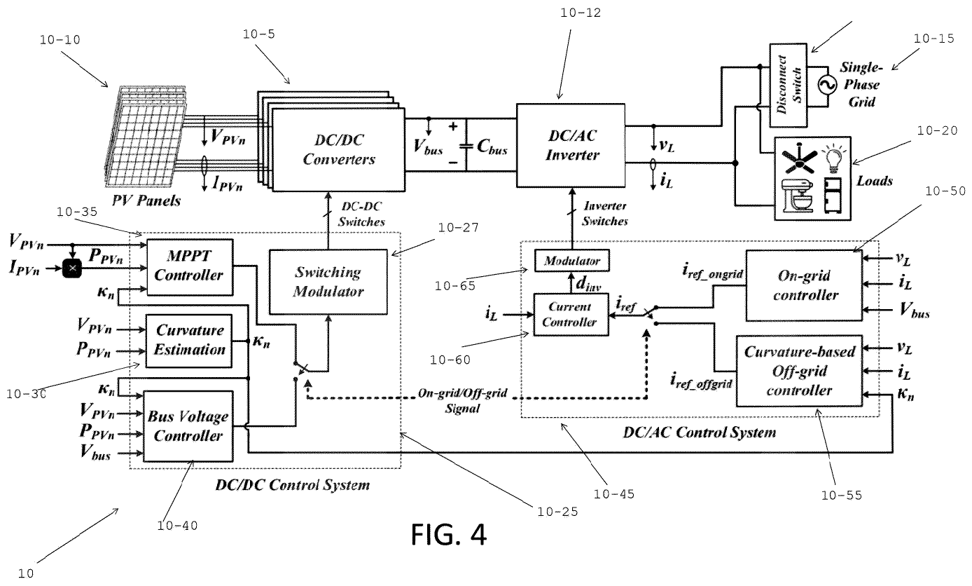

Referring to FIG. 4, a block diagram of a curvature-based microinverter control system with both on-grid and off-grid functionality is presented. A command signal for switching between on-grid and off-grid operation can be sent via a communications link if desired by the user—otherwise, the system operates autonomously. As can be seen from the diagram, the system 10 consists of the following blocks:
Multiple DC/DC Converters 10-5, which are responsible for extracting power from the photovoltaic panels 10-10 and delivering it to the DC bus. In on-grid mode, the DC/DC converters 10-5 perform maximum power point tracking (MPPT) and supply the extracted power to the DC bus. In off-grid mode, the DC/DC converters 10-5 regulate the bus voltage to a pre-set value. Examples of DC/DC converters suitable for this application include isolated topologies such as full-bridge converters, series-parallel (LLC) resonant converters, and others.
A single-phase DC/AC Inverter 10-12, which converts the DC power at the bus into single-phase AC power compatible with the grid 10-15 and/or local single-phase loads 10-20. As can be seen, a disconnect switch 10-22 is present to connect/disconnect the grid 10-15 or the loads 10-20 to/from the output of the inverter 10-12.
A DC/DC control system 10-25, which is responsible for efficient power processing from photovoltaic panels 10-10 for either MPPT or DC bus voltage regulation. This control system 10-25 uses the input voltage, VPVn, and current, IPVn, from the photovoltaic panels 10-10, along with the bus voltage, V_{bus}, information at the output of the each of the multiple DC/DC converters 10-5 to generate switching pulse references for the relevant DC/DC converter by way of a switching modulator block 10-27. The DC/DC control system 10-5 also includes a curvature estimation block 10-30. The curvature of the PV curve is utilized to optimize the MPPT operation (performed through the MPPT controller 10-35) by adaptively adjusting the step size of the algorithm based on the curvature, Kn. The curvature estimation from the curvature estimation block 10-30 also enables effective power sharing among the DC/DC converters 10-5 during off-grid operation, based on the curvature at their respective operating points on the PV (power-voltage) curves. The DC bus regulation is performed by way of a bus voltage controller 10-40. For clarity, the DC/DC control system 10-25 independently controls each of the DC/DC converters based on the output parameters for each DC/DC converter and the photovoltaic panels that DC/DC converter is coupled to. Each DC/DC converter and the photovoltaic panels coupled to that DC/DC converter operates as a DC power source and each DC power source is operated and controlled independently of the other DC power sources.
A DC/AC control system 10-45, which is responsible for delivering the harvested photovoltaic power to the grid and/or loads. In on-grid mode, this control system 10-45, by way of an on-grid controller 10-50, performs various functions such as bus voltage regulation, reactive VAR compensation, etc. In off-grid mode, the control system 10-45 regulates the AC voltage within a predefined range. The output of the curvature estimation block, Kn, from the DC/DC control system 10-25 is also utilized by the DC/AC control system 10-45 (by way of an off-grid controller 10-55) during off-grid operation. When multiple DC/DC converters 10-5 are connected to the microinverter input and the load demand approaches the maximum available photovoltaic power, the photovoltaic panel with the highest power capacity exhibits the largest radius of curvature because its associated DC/DC converter operates farthest from its MPP (maximum power point). Consequently, this panel's radius of curvature is used to adjust the current setpoint output of the off-grid controller 10-55. As the radius of curvature decreases, the amplitude of the current reference of the off-grid controller, i_{ref_offgrid}, (as shown in FIG. 4) is reduced. This can be achieved by multiplying the current reference with the estimated radius of the curvature. This reduction curtails the power delivered to the load when the photovoltaic power sources are near their capacity. Consequently, this approach enhances power sharing among parallel-connected inverters, tailored to the relative generation capacities of the photovoltaic panels that are part of the DC power sources. As can be seen, the DC/AC control system 10-45 has internal current references that are generated by either the on-grid controller 10-50 or by the off-grid controller 10-55. The relevant internal current references i_{ref_ongrid} and i_{ref_offgrid}, is used by a current controller 10-60 to generate a parameter dᵢₙᵥ that is used by a modulator 10-65 to generate control signals for the switches in the DC/AC inverter 10-12.

For clarity, it can be seen from FIG. 4 that an on-grid/off-grid signal is used to control the behaviour of both the DC/DC control system 10-25 and the DC/AC control system 10-45. This on-grid/off-grid signal, for the DC/DC control system 10-25, selects the input to the switching modulator block 10-27 to be either the output of the MPPT controller block 10-25 (for on-grid mode) or the output of the bus voltage controller 10-40 (for off-grid mode). For the DC/AC control system 10-45, the on-grid/off-grid signal selects one of the two internal current references i_{ref_ongrid}(for on-grid mode) and i_{ref_offgrid}(for off-grid mode) as input to the current controller 10-60.

For yet more clarity, power sharing between inverters coupled to a PCC (point of common coupling) is accomplished by, for each inverter, using a photovoltaic panel's estimated radius of curvature as a scaling factor on the current reference for the off-grid controller. Thus, assuming two inverters are coupled to a PCC and each inverter is coupled to different photovoltaic panels with different capacities (by way of different DC/DC converters), the photovoltaic panel with a lower capacity will, as it approaches its MPP, have a smaller radius of curvature for its output characteristic than for the photovoltaic panel with a higher capacity. Thus, by using this smaller radius of curvature as a scaling factor on the current reference i_{ref_offgrid}, the inverter coupled to the lower capacity photovoltaic panel will have a lower off-grid current reference and, accordingly, will contribute lesser power to the overall output AC power. The inverter coupled to the higher capacity photovoltaic panel will, accordingly, contribute more AC power to the overall output AC power as this inverter's off-grid current reference will have a larger scaling factor due to the larger radius of curvature of its higher capacity photovoltaic panel. The radius of curvature is therefore used to adjust power sharing between inverters coupled at a PCC.

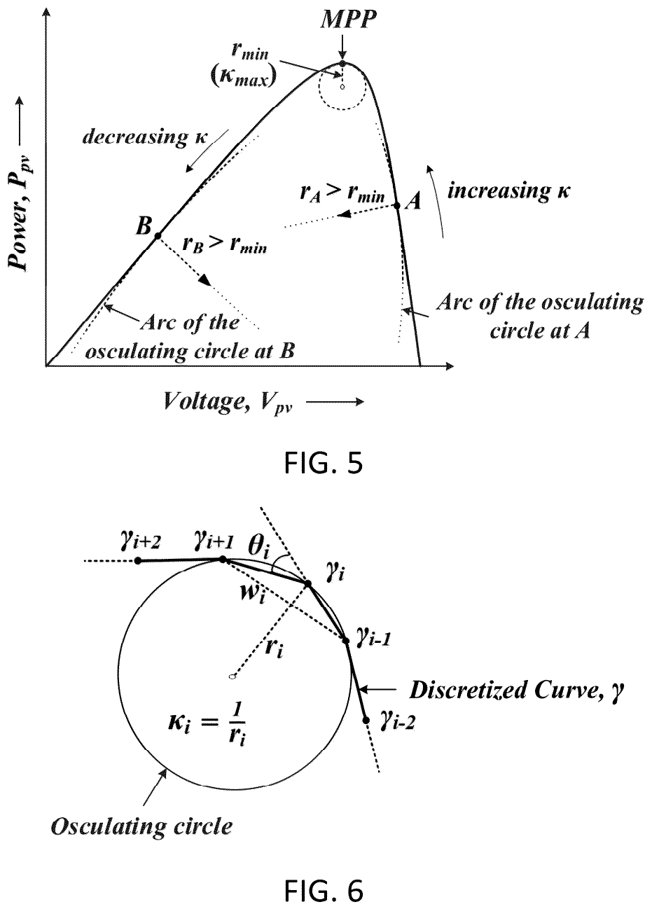

FIG. 5 depicts a power-voltage (PV) curve for a photovoltaic panel, showing the relationship between the power output P_{PV}(t) and the voltage V_{PV}(t). The peak of the curve indicates the maximum power point (MPP). The concept of the osculating circle can be used to determine the curvature at a specific point on a curve. The osculating circle is the circle that best approximates the curve at that point. The curvature, K, at a point is defined as the reciprocal of the radius, r, of the osculating circle, i.e.,

$$κ = \frac{1}{r} .$$

At the MPP, the curvature is maximum (κₘₐₓ) and the radius of curvature is minimum (rₘᵢₙ). To the right and left of the MPP (as also demonstrated by the points A and B in FIG. 5), the curvature of the PV curve is less.

FIG. 6 illustrates an exemplary arrangement of a method for calculating the discrete curvature in real time. It should be noted that several techniques exist in the literature for calculating discrete curvature (e.g. Steiner formula, turning angle, length variation, osculating circle, etc.). In the discrete case, a natural approach is to the consider the circumcircle (i.e., the osculating circle) passing through three consecutive vertices (γᵢ₋₁, γᵢ, γᵢ₊₁) of a discretized curve, γ (where i∈ [symbol] ). For the PV curve, each point on the curve, γᵢ can be parameterized as (V_{PV_i}, P_{PV_i}), where V_{PV_i} is the voltage and P_{PV_i} is the power output of the photovoltaic panel at that point. In this context, the discrete curvature, κᵢ, can be obtained by calculating the inverse of the radius, rᵢ, of the circumcircle.

$${κ}_{i} = \frac{1}{{r}_{i}} 0.$$

Geometrically, the curvature κᵢ can also be expressed as:

$${κ}_{i} = 2 ( \frac{{\vec{u}}_{i} Λ {\vec{v}}_{i}}{\vert {\vec{u}}_{i} \vert \vert {\vec{v}}_{i} \vert \vert {\vec{w}}_{i} \vert} )$$

where \vec{u}ᵢ is the displacement vector between the points γᵢ and γᵢ₊₁, \vec{v}ᵢ is the displacement vector between the points γᵢ₊₁ and γᵢ₊₂, and \vec{w}ᵢ is the displacement vector between the points γᵢ and γᵢ₊₂. The symbol (Λ) refers to the wedge product (or exterior product) between two vectors.

It should be clear that, while this document mostly refers to a power-voltage (PV) curve of the DC power source, other curves of output characteristics, such as power-voltage, power-current, or power-squared vs. voltage may be used. Any characteristic that exhibits maximum curvature at the maximum power point (MPP) may be used.

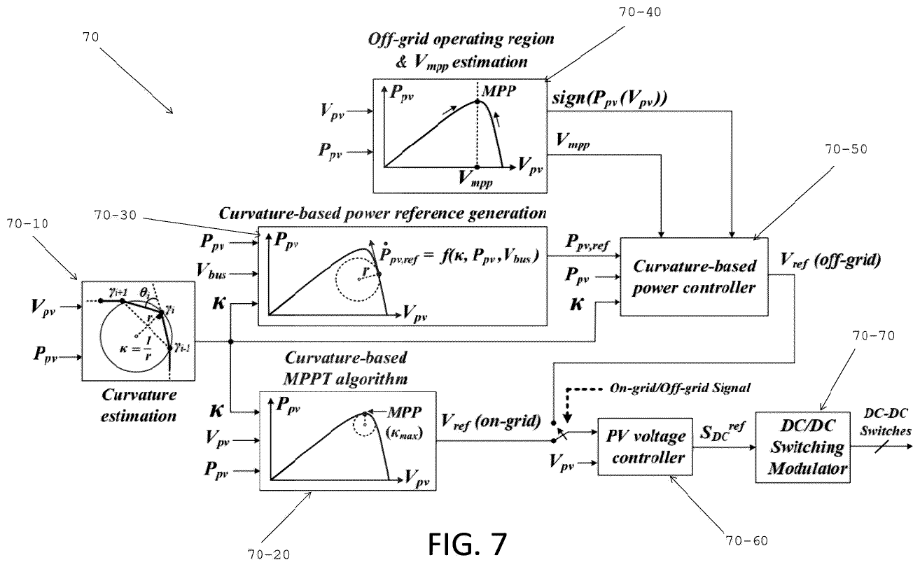

FIG. 7 illustrates a block diagram of a curvature-based control system for each DC/DC converter in a two-stage solar microinverter. As noted above, each DC/DC controller (or control system) uses the input voltage, V_{PV}, and power, P_{PV}, from a DC power source (i.e., from an associated or corresponding photovoltaic panel), along with the bus voltage, V_{bus}, to generate switching pulses for the DC power source's corresponding DC/DC converter. According to FIG. 7, the DC/DC control system 70 includes the following components:
A curvature estimation block 70-10, which calculates the curvature, K using the input voltage, V_{PV}, and power, P_{PV}, from the relevant photovoltaic panel(s);
A curvature-based MPPT method block 70-20, which generates the voltage reference, V_{ref}, for MPPT operation in on-grid mode;
A curvature-based power reference generation block 70-30, which uses the bus voltage, V_{bus}, input power, P_{PV}, and the curvature, K, to generate the power reference signal, P_{pv,ref}, for a DC/DC converter. Its primary objective is to regulate the bus voltage of the DC/DC converter while ensuring effective power sharing among DC/DC converters during off-grid operation. This is achieved by curtailing the power reference, P_{pv,ref}, for a DC/DC converter when its associated photovoltaic panel approaches its generation capacity. For instance, DC/DC converters within the microinverter typically implement a voltage droop on the DC bus and share power according to their capacities using virtual resistances. A higher virtual resistance effectively reduces the power-sharing burden on a DC/DC converter. Since the curvature reaches a maximum at the MPP, the virtual resistance can be scaled by the curvature to allow the DC/DC converter to reduce the power reference when operating too close to the MPP. Additionally, if other photovoltaic panels connected to different converters have higher generation capacities, their radius of curvature will be larger at the same operating power, allowing them to deliver more power to the DC bus and thereby reducing the load on converters/DC power sources with panels that have lower generation capacities. This ability allows for the curvature to be used to allow more effective power sharing between converters/DC power sources.
An off-grid operating region and MPP voltage (Vₘₚₚ) estimation block 70-40, which uses an algorithm to detect the region of operation on the power-voltage curve. It produces a signal, sign, indicating whether the operation is between voltages V_{oc} and Vₘₚₚ(sign=0) or below Vₘₚₚ(sign=1). The sign signal is a function of V_{PV} and P_{PV}. This block 70-40 also employs an algorithm to estimate Vₘₚₚ dynamically during off-grid mode under varying weather conditions;
A curvature-based power controller 70-50, which uses the power reference, P_{pv,ref}, the input power, P_{PV}, the curvature, K, from the power reference generation block 70-30 and the sign and Vₘₚₚ signals from the off-grid operating region and Vₘₚₚ estimation block 70-40 to generate the voltage reference, V_{ref}, for bus voltage regulation in off-grid mode;
A photovoltaic voltage controller 70-60, which uses the voltage reference, V_{ref}, either generated by the curvature-based power controller block or by the MPPT block, and the input voltage V_{PV}, to generate the switching reference signal,

$${S}_{ref}^{D C} ,$$

for use by a DC/DC switching modulator block 70-70 to generate the control signals for the DC/DC converter.
A DC/DC switching modulator block 70-70, which generates the switching pulses for the DC/DC converter switches using the

$${S}_{ref}^{D C}$$

signal produced by the photovoltaic voltage controller.

Referring the blocks of the control system in FIG. 7 back to FIG. 4, it can be seen that block 70-10 conforms to the curvature estimation block 10-30 in FIG. 4. As well, curvature-based MPPT method block 70-20 is used in the MPPT controller block 10-35 in FIG. 4. Finally, the curvature-based power reference generation block 70-30, off-grid operating region and MPP voltage estimation block 70-40, and curvature-based power controller 70-50 are all housed and used in the bus voltage controller 10-40 in FIG. 4. Finally, the photovoltaic voltage controller 70-60 and the DC/DC switching modulator 70-70 are both contained and used by the switching modulator block 10-27 in FIG. 4.

For greater clarity, power sharing between DC/DC converters coupled together at their output is accomplished by having lesser capacity photovoltaic panels produce less power as they approach their MPP. As noted above, photovoltaic panels with lower capacity have a smaller radius of curvature as they approach their MPP. Thus, for the same power level, photovoltaic panels with larger capacities will have a larger radius of curvature than lower capacity photovoltaic panels. By using a photovoltaic panel's curvature (i.e., 1/radius of curvature) as a scaling factor for virtual resistances, for the same operating power, lower capacity panels deliver less power while higher capacity panels deliver comparatively more power. This means that the virtual resistances are proportionally scaled by the curvature (i.e., 1/radius of curvature) and is, accordingly, inversely proportional to the radius of curvature. Accordingly, the DC/DC converter coupled to larger capacity photovoltaic panels deliver comparatively more power than DC/DC converters that are coupled to lower capacity photovoltaic panels as the lower capacity photovoltaic panels approach their MPP. The curvature of a photovoltaic panel's output characteristic is therefore used to determine/adjust power sharing between different DC/DC converters.

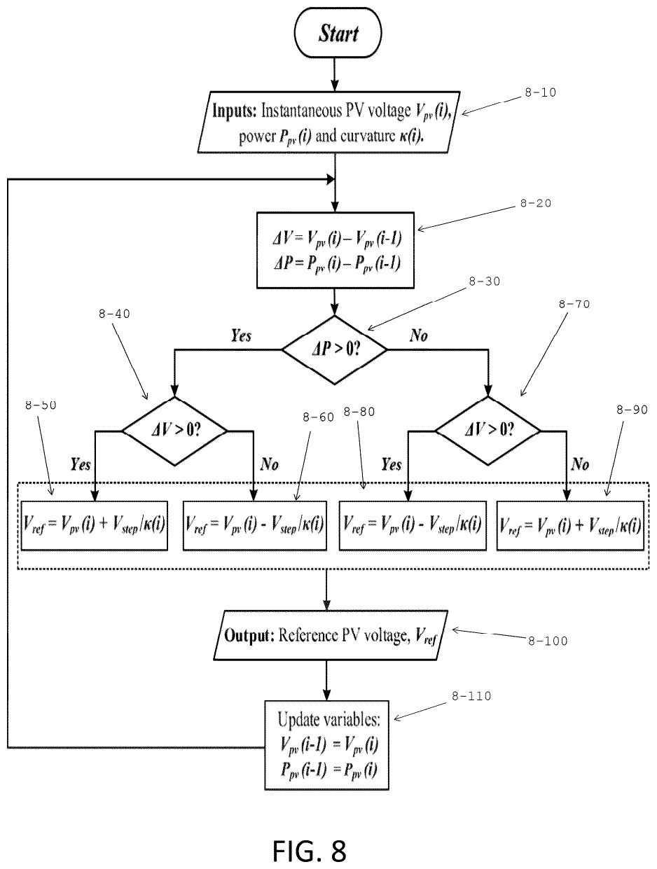

FIG. 8 illustrates a flowchart detailing the steps in a method for performing MPPT during on-grid operation of solar microinverters. As is known, MPPT seeks the maximum power point and, accordingly, tracking the MPP means traversing the PV (power-voltage) curve. As one traverses the PV curve, one's position on that curve affects the values used in to arrive at the next point in the curve (i.e., the next step). In this method, the curvature κ(i) is used to adjust the step size adaptively based on where one is (i.e., one's position) on the PV curve. Since the curvature is maximum at the MPP, the method operates to minimize the step size when one's position is near MPP. This is done to reduce voltage oscillations around the MPP, thereby enhancing energy harvesting efficiency. At points farther from the MPP, the step size is increased to accelerate the method's convergence. This adjustment is achieved by multiplying a constant step size, Vₛₜₑₚ, by the radius of curvature r(i) (where r(i)=1/κ(i)) to produce the voltage perturbation step. The method follows the following steps during each iteration:
Step 8-10: Start the method by collecting the following inputs: instantaneous photovoltaic voltage, Vₚᵥ(i), power, Pₚᵥ(i), and the curvature, κ(i).
Step 8-20: Calculate the differences between the current and previous values of photovoltaic voltage and power:

$$Δ V = {V}_{pv} ( i ) - {V}_{pv} ( i - 1 ) ,$$

$$Δ P = {P}_{pv} ( i ) - {P}_{pv} ( i - 1 ) .$$

Step 8-30: Evaluate the change in power and voltage (decision 8-30):
   a) If ΔP>0(positive power difference), check if ΔV>0(positive voltage difference at decision 8-40). If so, increase the reference voltage V_{ref} by Vₛₜₑₚ/κ(i) (step 8-50); otherwise, reduce V_{ref} by Vₛₜₑₚ/κ (i) (step 8-60). Here Vₛₜₑₚ and κ(i) are both positive values.
   b) If ΔP<0 check if ΔV>0(decision 8-70). If so, decrease V_{ref} by Vₛₜₑₚ/κ(i) (step 8-80); otherwise, increase V_{ref} by Vₛₜₑₚ/κ(i) (step 8-90).
Step 8-100: Output the reference photovoltaic voltage, V_{ref}, for the system to track.
Step 8-110: Update the stored values for the next iteration: Vₚᵥ(i−1)=Vₚᵥ(i), Pₚᵥ(i−1)=Pₚᵥ(i).

The voltage perturbation step Vₛₜₑₚ/κ(i) should have an upper limit (e.g. 5 V) to prevent very large voltage changes. Additionally, if ΔP≈0 and/or ΔV~0, no voltage perturbation is applied to reduce oscillations near the MPP.

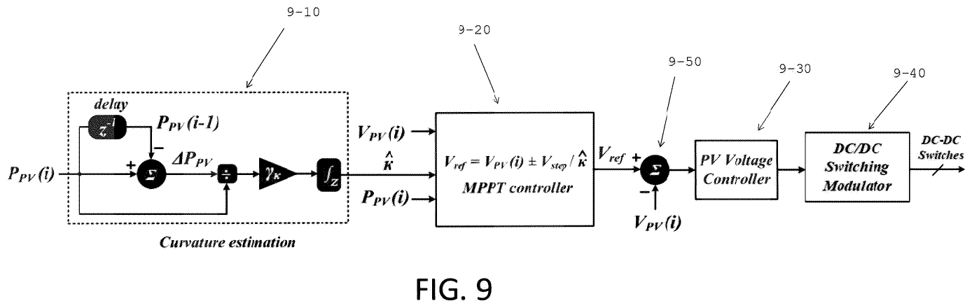

FIG. 9 illustrates an exemplary configuration for performing MPPT using an estimation of the curvature instead of calculating the discrete curvature. This configuration uses the difference between current and previous values of photovoltaic power, ΔPₚᵥ, along with the current value of photovoltaic power, Pₚᵥ(i), to estimate the curvature, of the operating point. The gain, γ_{κ}, of the integration block can be tuned to optimize the voltage perturbation step size. The control strategy aims to reduce the normalized power change ΔPₚᵥ/Pₚᵥ(i) to zero, which occurs at the MPP. By integrating this value (ΔPₚᵥ/P_{PV}(i)), the curvature information is obtained. Of course, as noted above, curvature reaches its peak at the MPP. This curvature estimate is then directly applied in the MPPT search method, allowing the system to optimally converge to the MPP by minimizing ΔPₚᵥ/Pₚᵥ(i).

As can be seen from FIG. 9, a curvature estimation block 9-10 implements the estimation of the curvature by determining the difference, ΔPₚᵥ, between current Pₚᵥ(i) and previous Pₚᵥ(i−1) values of photovoltaic power. The normalized power change value (ΔPₚᵥ/Pₚᵥ(i)) is then multiplied by gain, γ_{κ}, and the result is integrated. The result is the output of the curvature estimation block 9-10 and is the estimated curvature, \hat{κ}. This estimate is fed, along with current photovoltaic power Pₚᵥ(i), to an MPPT controller block 9-20. The MPPT controller block 9-20 also receives the photovoltaic voltage V_{PV}(i) and produces a reference voltage V_{ref} that is used, per the block diagram in FIG. 7, to generate switching pulses (by way of the photovoltaic voltage controller 9-30 and the DC/DC switching modulator 9-40) to control the DC-DC switches in the relevant DC-DC converter. As can be seen from FIG. 9, the photovoltaic voltage is subtracted from the reference voltage generated from MPPT controller block 9-20 and the result is then used by the photovoltaic voltage controller 9-30.

As can be imagined, the curvature estimation block 9-10 corresponds to the curvature estimation block 10-30 in FIG. 4. Similarly, the MPPT controller 9-20 corresponds to the MPPT controller 10-35 in FIG. 4. Finally, the photovoltaic voltage controller 9-30 and the DC/DC switching modulator 9-40 are both contained and used by the switching modulator block 10-27 in FIG. 4.

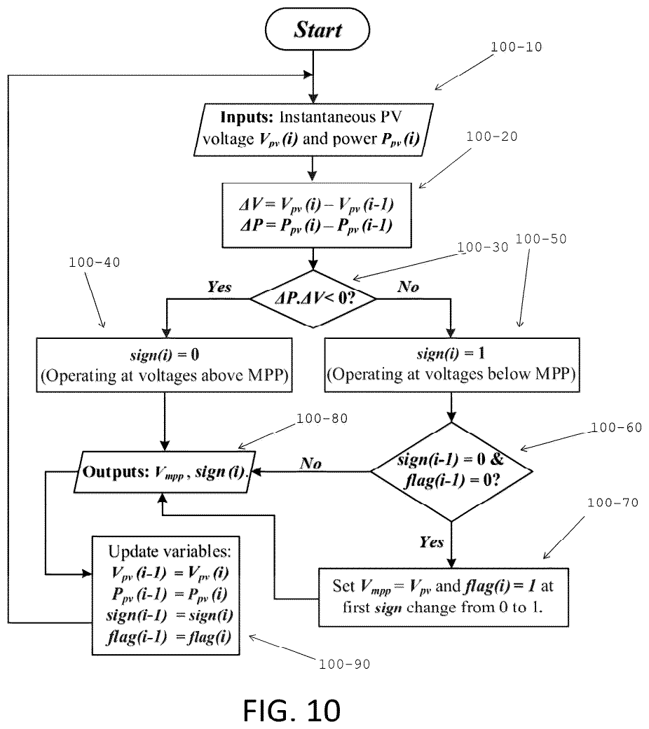

FIG. 10 illustrates an exemplary off-grid method that tracks the operating region of the photovoltaic system relative to the MPP and updates the MPP voltage estimate, Vₘₚₚ, based on the first detected change in the signal sign from 0 to 1. Each iteration of the method executes the following steps:
Step 100-10: The method starts with the collection of the following inputs: instantaneous photovoltaic voltage, Vₚᵥ(i), and power, Pₚᵥ(i).
Step 100-20: Calculate the differences between the current and previous values of photovoltaic voltage and power:

$$Δ V = {V}_{pv} ( i ) - {V}_{pv} ( i - 1 ) ,$$

$$Δ P = {P}_{pv} ( i ) - {P}_{pv} ( i - 1 ) .$$

Step/Decision 100-30: Evaluate the changes in power and voltage: If ΔP·ΔV>0, it indicates that the operating voltage is above the MPP, in which case sign(i) is set to 0(step 100-40). Conversely, if ΔP·ΔV<0, it means that the operating voltage is below the MPP, and sign(i) is set to 1 (step 100-50).
Steps 100-50 to 100-80: Detect the Vₘₚₚ point: If sign(i)=1 and sign(i-1)=0, while flag (i−1)=0(decision 100-60), then update MPP voltage estimate to Vₘₚₚ=Vₚᵥ(i) and set flag(i)=1(step 100-70). Afterwards, the logic moves to default step 100-80. Step 100-70 marks the first change from operation above to below the MPP. However, if the conditions sign(i−1)=0, while flag(i−1)=0 are not met, then logic move to default step 100-80.
Step 100-80: The method provides two outputs: Vₘₚₚ(the MPP voltage) and sign(i) (indicating whether the current operating point is above or below the MPP). Step 100-80 is executed when the conditions in decision 100-60 are not met or after step 100-70 is executed.
Step 100-90: After outputs are produced in step 100-80, the various variables are updated for the next iteration. The update step (step 100-90) includes updating the following variables for the next iteration: Vₚᵥ(i−1)=Vₚᵥ(i), Pₚᵥ(i−1)=Pₚᵥ(i), sign(i−1)=sign(i), flag(i−1)=flag(i). After updating these variables, the logic returns to the beginning at step 100-10.

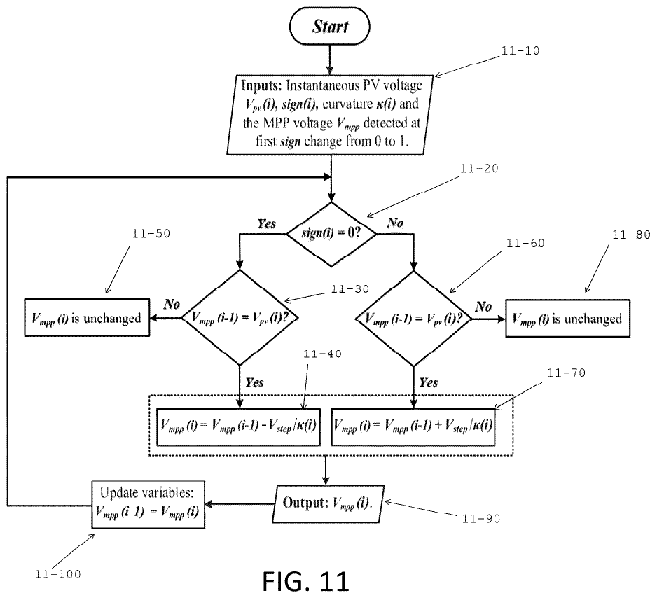

This off-grid method in FIG. 10 captures the MPP voltage estimate, Vₘₚₚ only at the first change in the sign signal from 0 to 1. This signal is fed into another off-grid MPP estimation method that tracks the MPP under varying environmental conditions where the Vₘₚₚ point may dynamically shift. The steps in this off-grid MPP estimation method are illustrated in FIG. 11.

FIG. 11 illustrates an exemplary method for tracking the Vₘₚₚ point as this point can dynamically vary with changing environmental conditions. Every iteration of the method executes the following steps:
Step 11-10: Start the method by collecting the following inputs: instantaneous photovoltaic voltage, Vₚᵥ(i), curvature, κ(i), and the signal sign(i) and Vₘₚₚ from the operating region detection method detailed in FIG. 10
Step/Decision 11-20: Check the signal sign(i) (decision 11-20) and whether the input voltage Vₚᵥ(i) is clamped to the estimated MPP voltage Vₘₚₚ(i−1):
   a) If sign(i)=0, check if Vₘₚₚ(i−1)=Vₚᵥ(i) (decision 11-30). If they are equal, decrease the MPP voltage Vₘₚₚ(i) by Vₛₜₑₚ/κ (i) (step 11-40); otherwise, leave Vₘₚₚ(i) unchanged (step 11-50). For this branch of the method logic, Vₛₜₑₚ and κ(i) are both positive values.
   b) If sign(i)=1, check if Vₘₚₚ(i−1)=Vₚᵥ(i) (decision 11-60). If they are equal, increase the MPP voltage Vₘₚₚ(i) by Vₛₜₑₚ/κ (i) (step 11-70); otherwise, leave Vₘₚₚ(i) unchanged (step 11-80).
Step 11-90: Output the current estimate of the MPP voltage Vₘₚₚ(i).
Step 11-100: Update the previous MPP voltage estimate for the next iteration:

$${V}_{mpp} ( i - 1 ) = {V}_{mpp} ( i ) .$$

The method in FIG. 11 optimizes the MPP search process during off-grid conditions. By incorporating the curvature estimate, the MPP point can be detected more quickly and accurately, even under varying environmental conditions.

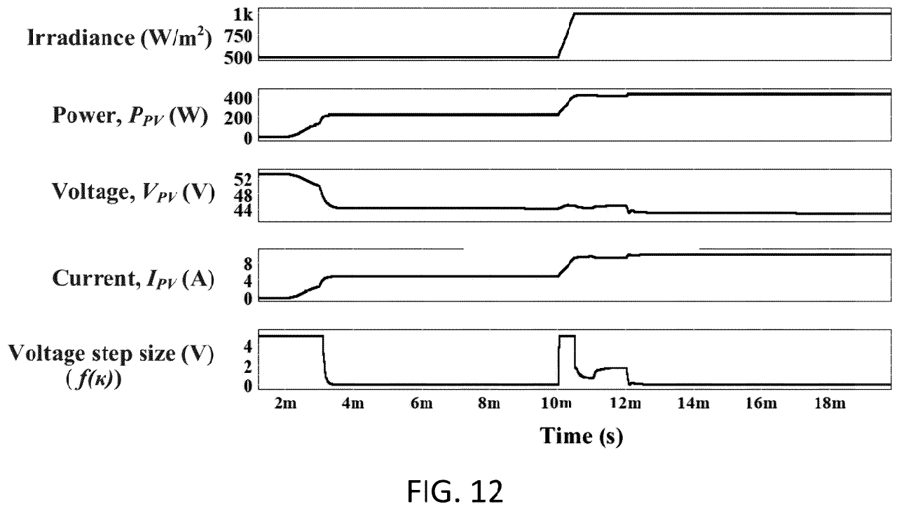

FIG. 12 shows the key waveforms that demonstrate the curvature-based control technique optimizing the operation of solar microinverters in on-grid mode while performing MPPT. These waveforms illustrate how the system quickly tracks the new MPP point after the irradiance on the solar panel increases from 500 W/m² to 1000 W/m². The output voltage is V_{PV}, the output power is P_{PV}, and the output current of the photovoltaic panels is Iₚᵥ. The voltage step size is a function of the curvature, κ.

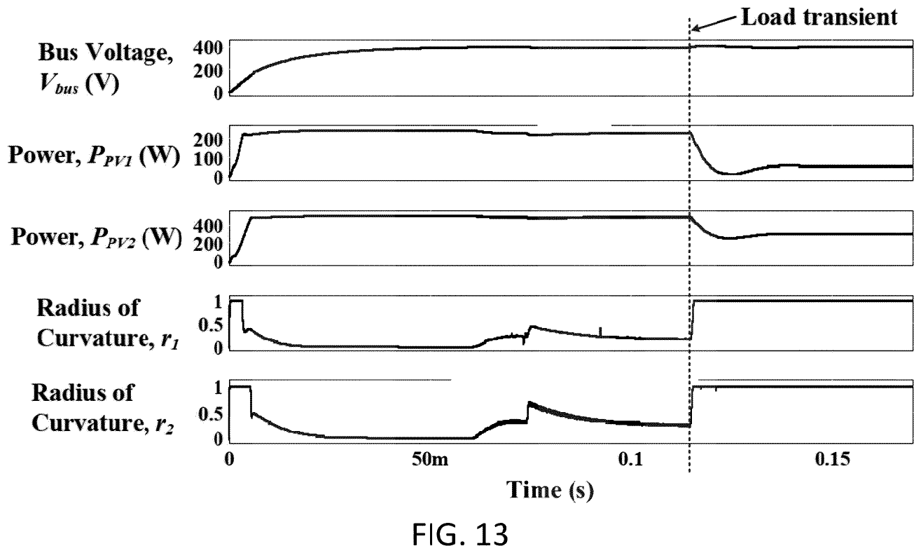

FIG. 13 shows the key waveforms demonstrating the off-grid operation of two DC/DC converters connected to photovoltaic panels with different maximum power ratings (250 W and 500 W) in response to a load transient. Initially, these photovoltaic panels supply power to a 720 W load, effectively sharing the power. After 110 ms, the load is reduced to half. The diagram illustrates the quick transient response of the control system to the load change, with minimal disturbance to the bus voltage, V_{bus}. It should be clear that Pₚᵥ₁ and Pₚᵥ₂ represent the power outputs of the DC/DC converters connected to the 250 W and 500 W panels, respectively. It should also be noted that r₁ and r₂ are the radii of curvature at the operating points of the DC/DC converters connected to the 250 W and 500 W panels, respectively.

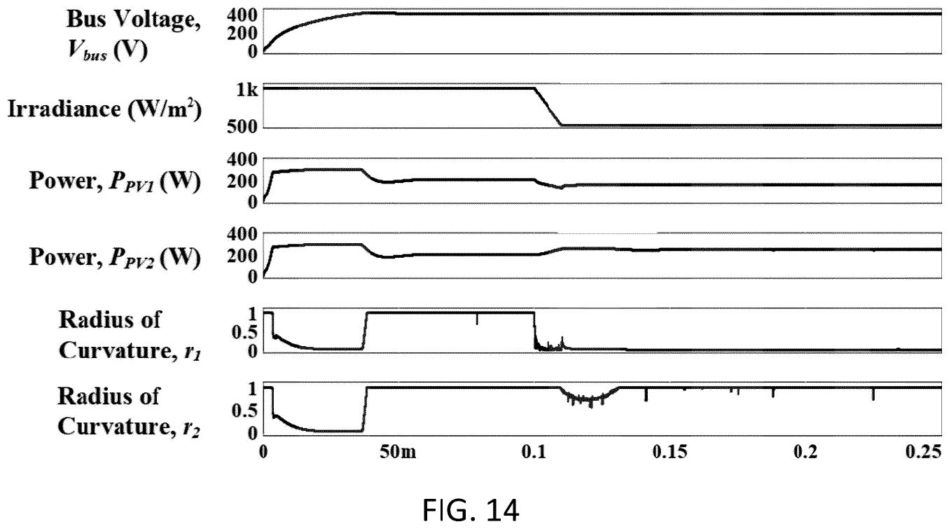

FIG. 14 shows the key waveforms demonstrating the off-grid operation of two DC/DC converters connected to photovoltaic panels with the same maximum power rating (300 W) in response to a change in irradiance. The DC/DC converters are sharing a 400 W load. The irradiance on one panel suddenly drops from 1000 W/m² to 500 W/m². This change alters the power distribution between the converters, causing each converter to settle at a new steady-state point.

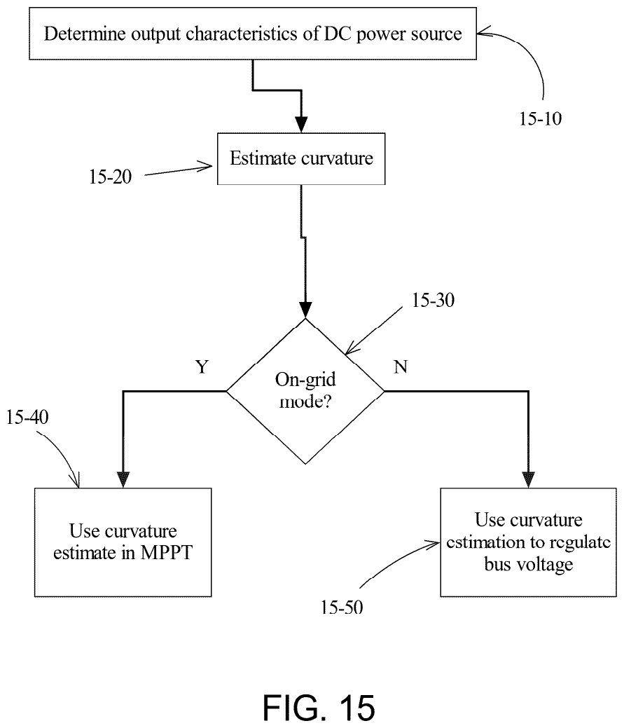

Referring to FIG. 15, illustrated is a flowchart showing the steps in a generalized method for controlling a DC power source using curvature estimation. As noted above, the DC power source may be a DC/DC converter coupled to a source for DC power (e.g., one or more photovoltaic panels). The method begins at step 15-10, that of determining the output characteristics of the DC power source. This can be done by measuring the output voltage and current of the DC power source. Power characteristics can then be derived from measured output voltage and current parameters of the DC power source. Once the relevant characteristics of the DC power source have been gathered and/or calculated, a curvature of the output characteristics is then estimated (step 15-20). As shown in the figures and as explained above, the curvature can be determined and/or estimated, in one implementation, an osculating circle. The next step is to determine if the control system controlling the DC power source is in off-grid or on-grid mode. For clarity, the flowchart decision 15-30 determines if the control system is in on-grid mode. If the system is in on-grid mode, then MPPT is executed using the curvature estimation (step 15-40). However, if the control system is not in on-grid mode, then the control system must be in off-grid mode and, accordingly, the curvature estimation is used in generating a power reference signal that regulates a bus voltage for the DC power source (step 15-50). It should also be clear that, in off-grid mode, the curvature is utilized not only for bus voltage regulation but also for optimizing power sharing between DC/DC converters and between inverters that are coupled to a point of common coupling.

In terms of implementation, the aspects of the present invention that involve methods may be implemented using well-known technologies such as digital signal processors (DSPs), microcontrollers, FPGAs (fixed pin grid arrays), and any other similar digital platform. Similarly, such aspects may be implemented using a general purpose data processing device/system.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A control subsystem for controlling a DC power source in a power generation system, the control subsystem comprising:
a maximum power point tracking (MPPT) controller for controlling power from said DC power source to thereby provide maximum power to a power grid when said control subsystem is in on-grid mode; and
a bus voltage controller for controlling said power from said DC power source to thereby provide said power to off-grid loads when said control subsystem is in off-grid mode,
wherein
said power generation system exclusively provides power to said power grid when said control subsystem is in said on-grid mode;
said power generation system exclusively provides power to said off-grid loads when said control subsystem is in said off-grid mode;
when said control subsystem is in said on-grid mode, said control subsystem uses an estimate of a curvature for an output characteristic of a component of said DC power source to perform maximum power point tracking with said DC power source; and
when said control subsystem is in said off-grid mode, said control subsystem uses said estimate of said curvature for said output characteristic of said component of said DC power source to perform at least one of:
determining a power reference signal that is used in regulating a bus voltage for said power generation system;
adjusting power sharing between a plurality of DC/DC converters that are connected to a DC bus of an AC inverter in said power generation system; and
adjusting power sharing between different AC inverters that are connected at a point of common coupling in said power generation system.

2. The control subsystem according to claim 1 wherein said DC power source comprises a DC/DC converter and at least one photovoltaic panel coupled to said DC/DC converter.

3. The control subsystem according to claim 1 wherein said output characteristic is a power-voltage characteristic for at least one photovoltaic panel that is said component of said DC power source.

4. The control subsystem according to claim 1 wherein said output characteristic is derived from sensed current and voltage outputs of said component of said DC power source.

5. The control subsystem according to claim 2 further comprising a switching modulator block for controlling switches in said DC/DC converter based on input from either said MPPT controller or said bus voltage controller,
wherein
when said control subsystem is in said on-grid mode, said switching modulator block receives input from said MPPT controller; and
when said control subsystem is in said off-grid mode, said switching modulator block receives input from said bus voltage controller.

6. The control subsystem according to claim 1, further comprising a curvature estimation block, said curvature estimation block receiving output parameters of said DC power source;
wherein
said curvature estimation block provides said estimate of said curvature for said output characteristic for said DC power source based on said output parameters; and
said MPPT controller and said bus voltage controller receive said estimate from said curvature estimation block.

7. A power generation system comprising:
a plurality of photovoltaic panels;
a plurality of DC/DC converters coupled at their outputs, each of said plurality of DC/DC converters being coupled at its input to at least one of said plurality of photovoltaic panels;
a DC/AC inverter receiving DC outputs of said plurality of DC/DC converters to thereby produce AC power;
a DC/DC control subsystem for providing signals to control switches in said plurality of DC/DC converters; and
a DC/AC control subsystem for providing signals to control switches in said DC/AC inverter,
wherein
said power generation system switchably operates exclusively in either on-grid mode or off-grid mode;
when said power generation system is in said on-grid mode, AC power from said DC/AC inverter is routed to a power grid;
when said power generation system is in said off-grid mode, AC power from said DC/AC inverter is routed to at least one off-grid load;
each of said plurality of DC/DC converters is paired with at least one corresponding photovoltaic panel to result in a DC power source such that each DC/DC converter is coupled to its corresponding at least one photovoltaic panel at an input of each DC/DC converter and such that said plurality of DC/DC converters and said plurality of photovoltaic panels result in a plurality of DC power sources for said power generation system;
said DC/DC control subsystem uses estimated curvatures of output characteristics of at least one component of said DC power sources to control a behavior of said DC power sources; and
said DC/AC control subsystem uses said estimated curvatures of output characteristics of at least one component of said DC power sources to control a behavior of said DC/AC inverter.

8. The power generation system according to claim 7 wherein each specific DC power source of said plurality of DC power sources is independently controlled by said DC/DC control subsystem from other specific DC power sources of said plurality of DC power sources and each specific DC power source of said plurality of DC power sources is controlled based on an estimated curvature of an output characteristic of at least one component of said specific DC power source.

9. The power generation system according to claim 7 wherein, when said power generation system is operating in said off-grid mode, said DC/AC control subsystem uses said estimated curvatures to regulate an output AC voltage to within a predefined range.

10. The power generation system according to claim 8, wherein said DC/DC control subsystem comprises:
a maximum power point tracking (MPPT) controller for controlling power from said specific DC power source to thereby provide maximum power to said power grid when said power generation system is operating in said on-grid mode; and
a bus voltage controller for controlling said power from said specific DC power source to thereby provide said power to said at least one off-grid load when said power generation system is operating in said off-grid mode.

11. The power generation system according to claim 10, wherein said DC/DC control subsystem comprises a switching modulator block for controlling switches in a DC/DC converter for said specific DC power source based on input from either said MPPT controller or said bus voltage controller,
wherein
when said power generation system is operating in said on-grid mode, said switching modulator block receives input from said MPPT controller; and
when said power generation system is operating in said off-grid mode, said switching modulator block receives input from said bus voltage controller.

12. The power generation system according to claim 10, wherein said DC/DC control subsystem further comprises a curvature estimation block, said curvature estimation block receiving output parameters of at least one component of said specific DC power source,
wherein
said curvature estimation block provides said estimate of said curvature for said output characteristic of said at least one component of said specific DC power source based on said output parameters; and
said MPPT controller and said bus voltage controller receives said estimate from said curvature estimation block.

13. The power generation system according to claim 8 wherein
for each specific DC power source, when said power generation system is operating in said off-grid mode, said DC/DC control subsystem uses said estimate of said curvature of said output characteristic of said at least one component of said specific DC power source to adjust a DC bus voltage for said power generation system towards a set value.

14. The power generation system according to claim 8 wherein
for each specific DC power source, when said power generation system is operating in said on-grid mode, said DC/DC control subsystem uses said estimate of said curvature of said output characteristic of said at least one component of said specific DC power source to perform maximum power point tracking with said specific DC power source.

15. The power generation system according to claim 8 wherein said output characteristic is derived from sensed current and voltage outputs of said at least one component of said specific DC power source.

16. The power generation system according to claim 15 wherein said output characteristic is one of:
a power-voltage characteristic;
a power-current characteristic;
a power-squared vs. voltage characteristic; and
an output characteristic that exhibits maximum curvature at a maximum power point (MPP).

17. A method for controlling a power generation system, the method comprising
a) determining output characteristics of at least one component of a DC power source that is part of said power generation system;
b) estimating a curvature of said output characteristics when said output characteristics are plotted to result in an estimated curvature; and
c) using said estimated curvature to generate a reference signal that adjusts a behavior of said power generation system.

18. The method according to claim 17 wherein the step c) comprises using said estimated curvature in maximum power point tracking (MPPT) for said DC power source.

19. The method according to claim 17 wherein the step c) comprises using said estimated curvature in a search for a maximum power point for said DC power source.

20. The method according to claim 17 wherein said estimated curvature is used for at least one of:
to determine a power reference signal that is used in regulating a bus voltage for said DC power source;
to determine power sharing between a plurality of DC/DC converters that are connected to a DC bus of an AC inverter in said power generation system; and
to determine power sharing between different AC inverters that are connected at a point of common coupling in said power generation system.

21. The method according to claim 17 wherein said DC power source comprises a DC-DC converter and at least one photovoltaic panel coupled to said DC-DC converter.
